(19) United States
(12) Patent Application Publication
(10) Pub. No.: US 2008/0109587 A1
(43) Pub. Date: May 8, 2008

(54) SWITCH CONTROL OF USB TRANSCEIVER BETWEEN A PLURALITY OF PROCESSORS

(75) Inventors: Philip Paul P. Greenhalgh, Swanbourne (AU); Aaron T. Applegate, Chandler, AZ (US); Miriam Y. Avello, Ft. Lauderdale, FL (US); Ashley James Lawrie, Oakden (AU); Taw Lim, Lauderhill, FL (US); Nikhil Mhatre, Plantation, FL (US); Joseph Patino, Pembroke Pines, FL (US); Robert H. Pichette, Plantation, FL (US); Marco Pulido, Miramar, FL (US); Jose F. Rodriguez, Miami, FL (US); Stefan Petkov P. Stefanov, Sheidow Park (AU); James R. Wise, Monroe, NC (US); WenJiong Yang, Boca Raton, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/556,066

(22) Filed: Nov. 2, 2006

(51) Int. Cl. G06F 13/00

(52) U.S. Cl. 710/316

(57) ABSTRACT

A device (100) that includes a communications port (130), a first processor (135), at least a second processor (140), and a multiplexer (105). The multiplexer can selectively communicatively link the communications port to the first processor or the second processor. The multiplexer can include at least one switch (110, 115) and a switch controller (120) that controls operation of the switch. The switch controller can be responsive to at least one control signal (125) generated by the first processor. The first processor can generate the control signal in response to a command received from an external device (155) connected to the communications port. The command can be an attention command or a test software command. The switch controller also can be responsive to at least one control signal generated by the second processor.

### BACKGROUND OF THE INVENTION

1. Field of the Invention

The present invention generally relates to multi-processor devices that include communications ports.

2. Background of the Invention

Communication devices, such as mobile stations, computers, and the like oftentimes include a plurality of processors. In some devices, each of the processors can be optimized to perform certain tasks, while in other devices the processors are configured to perform any tasks to which they are assigned.

In a typical multi-processor environment, data communicated via a communications port, such as a universal serial bus (USB) port, is routed through a primary processor using a serial interface before being communicated to another processor which may be tasked with processing the data. Some of these implementations monitor the serial interface by use of general purpose input/output (GPIO) communication. The GPIO typically determines when an external device is connected to the data port and monitors received signals to determine which processor should communicate with the external device.

As multi-processor systems are currently implemented, even if a second processor is tasked with processing communications from the external device, the primary processor is still burdened with supporting the serial interface through which the data is communicated, thereby tying up a portion of the primary processor's resources.

### SUMMARY OF THE INVENTION

The present invention relates to a device that includes a communications port, a first processor, at least a second processor, and a multiplexer. The multiplexer can selectively communicatively link the communications port to the first processor or the second processor. The multiplexer can include at least one switch and a switch controller that controls operation of the switch. The switch controller can be responsive to at least one control signal generated by the first processor.

The first processor can generate the control signal in response to a command received from an external device connected to the communications port. The command can be an attention command or a test software command. The switch controller also can be responsive to at least one control signal generated by the second processor. The second processor can generate the control signal in response to a command received from an external device connected to the communications port. The command can be an attention command or a test software command. The switch controller also can be responsive to at least one control signal generated by the first processor and at least one control signal generated by the second processor.

In one arrangement the switch can include at least a first transistor that, when appropriately biased, provides a communication path between a first node of the switch and a second node of the switch, and at least a second transistor that, when appropriately biased, provides a communication path between the first node of the switch and a third node of the switch.

The device also can include a first transceiver communicatively linked to the first processor and a second transceiver communicatively linked to the second processor. In one aspect of the invention, the communications port is a universal serial bus port or an IEEE-1394 port.

The present invention also relates to a method for selectively linking a communications port to a plurality of processors. The method can include receiving a command from an external device via a communications port. Responsive to the command indicating that a specific processor is requested, a control signal can be communicated to a multiplexer to communicatively link the external device to the requested processor. Receiving the command can include receiving an attention command or a test software command.

### BRIEF DESCRIPTION OF THE DRAWINGS

Preferred embodiments of the present invention will be described below in more detail, with reference to the accompanying drawings, in which:

FIG. 1 depicts a communications signal multiplexing system that is useful for understanding the present invention; and

FIG. 2 is a flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a multiplexer that selectively links a communications port to a plurality of processors. For example, if signals communicated via the communications port are relevant to a first processor, the multiplexer can communicatively link the communications port to the first processor. If, however, the signals communicated on the communications port are relevant to a second processor, the multiplexer can communicatively link the communications port to the second processor. Routing of the communication signals can be performed using switches that are implemented as hardware, thereby minimizing processor resources that are required to multiplex the communication signals.

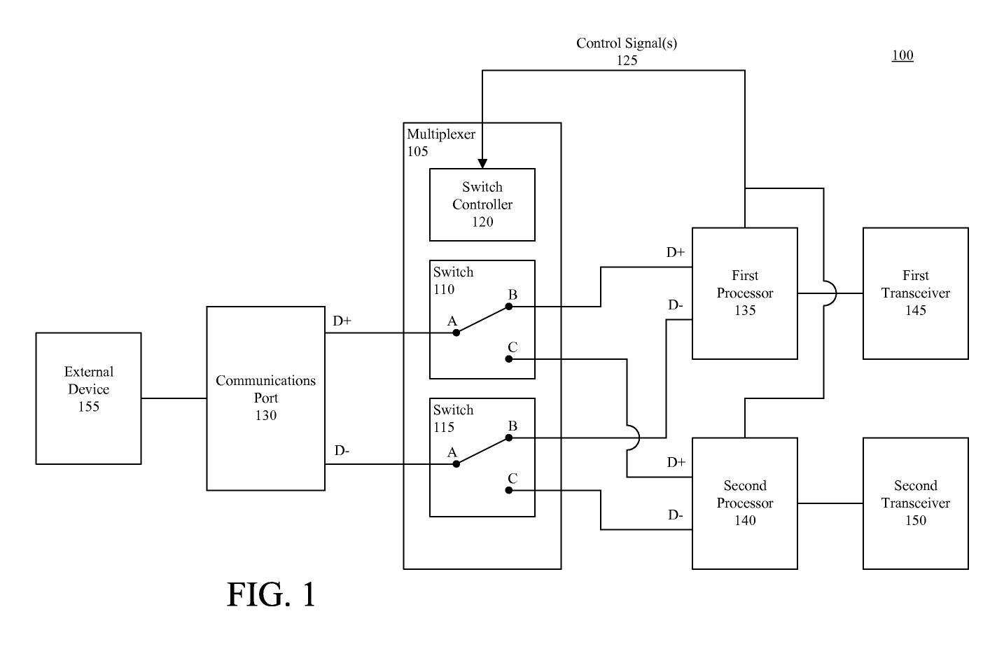

FIG. 1 depicts a communications signal multiplexing system (hereinafter “system”) 100 that is useful for understanding the present invention. The system 100 can include a multiplexer 105. The multiplexer 105 can comprise a plurality of switches 110, 115. In one arrangement, the switches 110, 115 can be implemented electronically. For example, the switches 110, 115 each can include one or more transistors that, when appropriately biased, provide a communication path between node A and node B of the respective switches 110, 115. Similarly, the switches 110, 115 each can include one or more transistors that, when appropriately biased, provide a communication path between node A and node C of the respective switches 110, 115. In an arrangement in which the system 100 includes more than two processors, each of the switches 110, 115 can include additional nodes (not shown) and additional transistors to provide communication links between such nodes and their respective nodes A.

In an arrangement in which the switches are electromechanical, each of the switches 110, 115 can comprise single pole, multi-throw switches. Alternatively, together the switches 110, 115 can be implemented using a double pole, multi-throw configuration. Still, the switches 110, 115 can be implemented in any other suitable manner and the invention is not limited in this regard.

The multiplexer 105 also can include a switch controller 120 that controls operation of the switches 110, 115 in response to one or more control signals 125. For example, in an arrangement in which the switches 110, 115 are implemented electronically, the switch controller 120 can bias the appropriate transistors in the switches to establish the desired communication paths. In an arrangement in which the switches 110, 115 are implemented electromechanically, for example using electromagnets that operate mechanical contacts, the switch controller 120 can control the current applied to the electromagnets to control whether the mechanical contacts are opened or closed. The switch controller 120 can control the switches 110, 115 in any other suitable manner and the invention is not limited in this regard.

The multiplexer 105 can selectively link a communications port 130 to a first processor 135, a second processor 140, and/or any other desired processors (not shown). The communications port 130 can be a universal serial bus (USB) port (e.g. a standard USB port, a mini USB port or a micro USB port), an IEEE-1394 port, or any other suitable communications port. The communications port 130 can include a suitable transceiver. For example, in an arrangement in which the communications port 130 is a USB port, the communications port 130 can include a USB transceiver. Similarly, in an arrangement in which the communications port 130 is an IEEE-1394 port, the communications port can include an IEEE-1394 transceiver.

The first processor 135 can comprise, for example, a central processing unit (CPU), a digital signal processor (DSP), an application specific integrated circuit (ASIC), a programmable logic device (PLD), a plurality of discrete components that cooperate to process data, and/or any other suitable processing device. Similarly, the second processor 140 can comprise a CPU, a DSP, an ASIC, a PLD, a plurality of discrete components that cooperate to process data, and/or any other suitable processing device. The first processor 135 can be communicatively linked to a first transceiver 145 and used for communicating in a first communication mode, for example a dispatch mode. Similarly, the second processor 140 can be communicatively linked to a second transceiver 150 and used for communicating in a second communication mode, for example an interconnect mode.

In one aspect of the invention, the multiplexer 105 can operate between a first configuration in which the switches 110, 115 communicatively link terminals D+ and D− of the communications port 130 with respective terminals D+ and D− of the first processor 135, and a second configuration in which the switches 110, 115 communicatively link terminals D+ and D− of the communications port 130 with respective terminals D+ and D− of the second processor 140. The multiplexer 105 also can configure the switches 110, 115 to unlink the communications port 130 from both the first processor 135 and the second processor 140.

In one arrangement, the control signals 125 can be generated by the first processor 135. For example, when a device 155 is first connected to the communications port 130, by default the switches 110, 115 can communicatively link the communications port 130 to the first processor 135. After being connected, the device 155 can communicate a command via the communications port 130 that indicates to the first processor 135 which of the first and second processors 135, 140 are requested by the device. An example of such a command can be an attention (AT) command or test software command. An example of an AT command can have a syntax of “AT+xxx=d”; where “xxx” is a specific command, and “d” is an integer indicating to which processor 135, 140 to communicatively link to the communications port 130. An example of a test software command can have a syntax of “CMD <processor name>”; where CMD can be any combination of a character set (i.e. a human readable command) and <processor name> is passed as a parameter to indicate which processor 135, 140 should be communicatively linked to the communications port 130.

If the command indicates that the device 155 requests the first processor 135, the first processor 135 can generate control signals 125 which indicate to the switch controller 120 to keep the switches 110, 115 in their default states. If, however, the command indicates that the second processor 140 is requested by the device, the first processor 135 can generate control signals 125 which indicate to the switch controller 120 to change the state of the switches 110, 115 to communicatively link the communications port 130 to the second processor 140. The first processor 135 also can communicate an attention command to the second processor 140 via an inter-processor communication channel.

In another arrangement, the second processor 140 also can be configured to process the command from the device 155 which indicates the processor 135, 140 that is requested by the device 155. Thus, if the switches 110, 115 are in a state in which the communications port 130 is communicatively linked to the second processor 140, and the device 155 issues a command requesting a communication link to the first processor 135, the processor 140 can process such command and generate corresponding control signals 125. Further, other processors that may be linked to the multiplexer 105 also can be configured to process the commands.

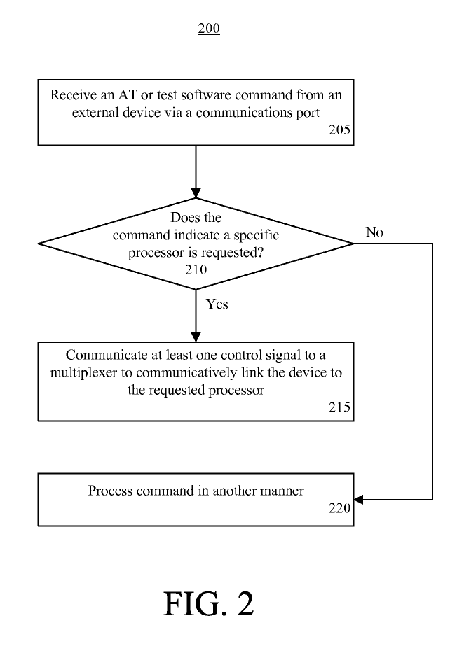

FIG. 2 is a flowchart that presents a method 200 which is useful for understanding the present invention. Beginning at step 205, an attention (AT) command or a test software command can be received from an external device via a communications port. Referring to decision box 210, if the command indicates that a specific processor is requested by the external device, at step 215 at least one control signal can be communicated to a multiplexer to communicatively link the communications port, and hence the external device, to the requested processor via the communication port. If, however, the command does not request a specific processor, at step 220 the command can be processed in a suitable manner.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A device, comprising:
a communications port;
a first processor;
at least a second processor; and
a multiplexer that selectively communicatively links the communications port to the first processor or the second processor.

2. The device of claim 1, wherein the multiplexer comprises:
at least one switch; and
a switch controller that controls operation of the switch.

3. The device of claim 2, wherein the switch controller is responsive to at least one control signal generated by the first processor.

4. The device of claim 3, wherein the first processor generates the control signal in response to a command received from an external device connected to the communications port.

5. The device of claim 4, wherein the command is an attention command.

6. The device of claim 4, wherein the command is a test software command.

7. The device of claim 2, wherein the switch controller is responsive to at least one control signal generated by the second processor.

8. The device of claim 7, wherein the second processor generates the control signal in response to a command received from an external device connected to the communications port.

9. The device of claim 8, wherein the command is an attention command.

10. The device of claim 8, wherein the command is a test software command.

11. The device of claim 2, wherein the switch controller is responsive to at least one control signal generated by the first processor and at least one control signal generated by the second processor.

12. The device of claim 2, wherein the switch comprises:
at least a first transistor that, when appropriately biased, provides a communication path between a first node of the switch and a second node of the switch; and
at least a second transistor that, when appropriately biased, provides a communication path between the first node of the switch and a third node of the switch.

13. The device of claim 1, further comprising:
a first transceiver communicatively linked to the first processor; and
a second transceiver communicatively linked to the second processor.

14. The device of claim 1, wherein the communications port is a universal serial bus port.

15. The device of claim 1, wherein the communications port is an IEEE-1394 port.

16. A device, comprising:
a communications port;
a first processor;
at least a second processor; and
a multiplexer that selectively communicatively links the communications port to the first processor or the second processor, the multiplexer comprising:
at least one switch; and
a switch controller that controls operation of the switch;
wherein the switch controller is responsive to at least one control signal generated by the first processor in response to a command received from an external device connected to the communications port.

17. The device of claim 16, wherein the command is an attention command or a test software command.

18. A method for selectively linking a communications port to a plurality of processors, comprising:
receiving a command from an external device via a communications port; and
responsive to the command indicating that a specific processor is requested, communicating a control signal to a multiplexer to communicatively link the external device to the requested processor.

19. The method of claim 18, wherein receiving the command comprises receiving an attention command.

20. The method of claim 18, wherein receiving the command comprises receiving a test software command.
